(19) United States
(12) Patent Application Publication
(10) Pub. No.: US 2012/0161520 A1
(43) Pub. Date: Jun. 28, 2012

(54) DOUBLE LOOP STRUCTURE

(75) Inventors: Shunsaku KOGA, Tokyo (JP); Junichi KITANO, Tokyo (JP); Haruo IKEDA, Tokyo (JP)

(73) Assignee: CENTRAL JAPAN RAILWAY COMPANY, Tokyo (JP)

(21) Appl. No.: 13/333,435

(22) Filed: Dec. 21, 2011

(30) Foreign Application Priority Data
Dec. 28, 2010 (JP) 2010-293401

(51) Int. Cl. H02J 3/00

(52) U.S. Cl. 307/43

(57) ABSTRACT

A double loop structure includes: a first feed loop that is connected to a first high-frequency power source and energized; and a second feed loop which is connected to a second high-frequency power source, and in which an induced voltage is induced by the first feed loop. The first feed loop is provided with at least one twisting point a predetermined distance apart from the first high-frequency power source, or the second feed loop is provided with at least one twisting point a predetermined distance apart from the second high-frequency power source.

### CROSS-REFERENCE TO RELATED APPLICATIONS

This application claims the benefit of Japanese Patent Application No. 2010-293401 filed Dec. 28, 2010 in the Japan Patent Office, the disclosure of which is incorporated herein by reference.

### BACKGROUND

The present invention relates to a double loop structure constituted by a first feed loop, which is connected to a first high-frequency power source, and a second feed loop, which is arranged in parallel with the first high-frequency power source and connected to a second high-frequency power source.

Conventionally, a feed loop having a so-called single loop structure (for example, in Japanese Unexamined Patent Application Publication No. 2006-50852) is known. The single loop structure is connected to a high-frequency power source and is provided with a condenser having a predetermined capacitive reactance (1/ωC). The feed loop has a function as an energized loop which is constantly energized.

In this case, the feed loop itself is regarded as a coil, and the condenser is selected to have a capacitive reactance which is equal to an inductive reactance (ωL) of the coil. This is because when the capacitive reactance is equal to the inductive reactance, impedance in the entire feed loop is made zero, which allows efficient current flow in the feed loop.

In recent years, a double loop structure has been proposed in order to improve reliance on an energized loop. The double loop structure is constituted by two feed loops, each having a so-called single loop structure. An example of such double loop structure is a double loop structure constituted by a feed loop and a waiting loop. The feed loop functions as an energized loop which is constantly energized, while the waiting loop functions as a backup loop for the energized loop. In this example, both the energized loop and the waiting loop are connected to high-frequency power sources, although only the energized loop is energized and the waiting loop is not energized. Another example is a double loop structure including two feed loops that function as energized loops which are constantly energized.

Hereinafter, a position of a high-frequency power source is regarded as a starting end, a longitudinal end of the waiting loop (a turn-around end of the loop) is regarded as a finishing end, and a distance from the position of the high-frequency power source to the turn-around end of the loop is referred to as a loop length.

### SUMMARY

When the high-frequency power source is turned on, and thereby an alternating current flows through one feed loop as an energized loop, an induced voltage is generated in the other feed loop as a waiting loop. Here, an explanation will be provided on a relationship between the induced voltage induced in the waiting loop and a distance from the high-frequency power source with reference to FIG. 8. FIG. 8 is a graph showing the relationship between the induced voltage (in a vertical axis) generated in the waiting loop and the distance from the high-frequency power source (in a horizontal axis).

As shown in FIG. 8, the induced voltage induced in the waiting loop increases as the distance from the high-frequency power source connected to the energized loop increases. Accordingly, as a loop length of the feed loop constituting a double loop structure become longer, the induced voltage induced in the waiting loop becomes excessively larger.

The present invention has been made in view of such problem, and a double loop structure according to the present invention enables to suppress increase in induced voltage.

A double loop structure according to a first aspect of the present invention includes: a first feed loop (an energized loop) and a second feed loop (a waiting loop). The first feed loop is connected to a first high-frequency power source and energized. The second feed loop is connected to a second high-frequency power source, and an induced voltage is induced in the second feed loop by the first feed loop.

The first feed loop is provided with at least one twisting point a predetermined distance apart from the first high-frequency power source. With this configuration, a direction of a magnetic field provided by the first feed loop to the second feed loop can be made opposite starting from the at least one twisting point since the first feed loop is twisted at the at least one twisting point.

The induced voltage induced by the first feed loop in the second feed loop from the second high-frequency power source to a longitudinal end (a turn-around end of the loop) of the second feed loop changes specifically as below.

When the first high-frequency power source is turned on, and current flows in the first feed loop, an induced voltage is induced in the second feed loop. The induced voltage continues to increase as a distance from the first high-frequency power source increases. Then, a direction of a magnetic field provided by the first feed loop to the second feed loop becomes opposite starting from a twisting point of the first feed loop, a direction of the induced voltage induced in the second feed loop becomes opposite starting from the twisting point. Accordingly, the induced voltage in the second feed loop decreases starting from the twisting point, as the distance from the first high-frequency power source increases.

In a case where the first feed loop is not twisted, the induced voltage induced in the second feed loop continues to increase as the distance from the first high-frequency power source increases. Accordingly, increase in induced voltage can be suppressed, as compared with the case where the first feed loop is not twisted.

A double loop structure according to a second aspect of the present invention includes: a first feed loop (an energized loop) and a second feed loop (a waiting loop). The first feed loop is connected to a first high-frequency power source and energized. The second feed loop is connected to a second high-frequency power source, and an induced voltage is induced in the second feed loop by the first feed loop. The second feed loop is provided with at least one twisting point a predetermined distance apart from the second high-frequency power source. With this configuration, a direction of a magnetic field provided to the second feed loop can be made opposite starting from the at least one twisting point since the second feed loop is twisted at the at least one twisting point.

The induced voltage induced in the second feed loop from the second high-frequency power source via the twisting point to a longitudinal end of the second feed loop changes specifically as below.

When the first high-frequency power source is turned on, an induced voltage is induced in the second feed loop. The induced voltage continues to increase as a distance from the first high-frequency power source increases. Then, a direction of a magnetic field provided by the first feed loop to the second feed loop becomes opposite starting from the twisting point, and a direction of the induced voltage induced in the second feed loop becomes opposite. Accordingly, the induced voltage in the second feed loop decreases starting from the twisting point, as the distance from the first high-frequency power source increases.

In a case where the second feed loop is not twisted, the induced voltage induced in the second feed loop continues to increase as the distance from the first high-frequency power source increases. Accordingly, increase in induced voltage can be suppressed, as compared with the case where the second feed loop is not twisted.

According to a third aspect of the present invention, it is preferable that the first feed loop is provided with a plurality of twisting points such that distances between each two adjacent twisting points are equal. With the plurality of twisting points, a direction of a magnetic field provided to the second feed loop is changed to an opposite direction (a first direction) at the first twisting point counted from the first high-frequency power source, and the direction of the magnetic field provided to the second feed loop is changed to a direction (a second direction) opposite to the first direction at a next twisting point. Subsequently, the direction is changed alternately to the first direction or the second direction in a repeated manner at each of the subsequent twisting points.

When the first high-frequency power source is turned on and current flows in the first feed loop, an induced voltage is induced in the second feed loop. The induced voltage increases by a predetermined amount from the first high-frequency power source to the first twisting point, decreases by a same amount as the predetermined amount from the first twisting point to the next twisting point, and then increases by the same amount as the predetermined amount from the next twisting point to a further next twisting point. Since such increase and decrease is repeated further, the induced voltage induced in the second feed loop will not continue to increase. Thus, increase in induced voltage in the second feed loop can be suppressed.

According to a fourth aspect of the present invention, it is preferable that the second feed loop is provided with a plurality of twisting points such that distances between each two adjacent twisting points are equal. With the plurality of twisting points, a direction of a magnetic field provided to the second feed loop is changed to an opposite direction (a first direction) at the first twisting point counted from the second high-frequency power source, and the direction of the magnetic field provided to the second feed loop is changed to a direction (a second direction) opposite to the first direction at a next twisting point. Subsequently, the direction of the magnetic field provided to the second feed loop is changed alternately to the first direction or the second direction in a repeated manner at each of the subsequent twisting points.

When the first high-frequency power source is turned on and current flows in the first feed loop, an induced voltage is induced in the second feed loop. The induced voltage increases by a predetermined amount from the second high-frequency power source to the first twisting point, decreases by a same amount as the predetermined amount from the first twisting point to a next twisting point, and then increases by the same amount as the predetermined amount from the next twisting point to a further next twisting point. Since such increase and decrease is repeated, the induced voltage induced in the second feed loop will not continue to increase. Thus, increase in induced voltage in the second feed loop can be suppressed.

A double loop structure according to a fifth aspect of the present invention includes: a first feed loop (a first energized loop) that is connected to a first high-frequency power source and energized, and a second feed loop (a second energized loop) that is connected to a second high-frequency power source and energized. The first feed loop is provided with a plurality of twisting points. The second feed loop is provided with a plurality of twisting points, each of which is arranged so as to correspond to a section between each two adjacent twisting points of the first feed loop. With this configuration, a direction of a magnetic field provided by the first feed loop to the second feed loop can be made opposite starting from each of the twisting points of the first feed loop since the first feed loop is twisted at the each of the twisting points. Also, a direction of a magnetic field provided by the second feed loop to the first feed loop can be made opposite starting from each of the twisting points of the second feed loop since the second feed loop is twisted at the each of the twisting points.

That is, one twisting point of the second feed loop is arranged so as to correspond to a section (a twist section A1) between two adjacent twisting points of the first feed loop, and another twisting point of the second feed loop is arranged so as to correspond to a twist section B1 of the first feed loop which is adjacent to the twist section A1. Such arrangement of the twisting points is repeated through to respective longitudinal ends of the first feed loop and the second feed loop.

Basically, in a double loop structure including two feed loops, a factor of mutual inductance M is added and thereby a resonance frequency is shifted. As a result, it is impossible to allow current to flow efficiently and thus is impossible to collect current.

With the above described configuration of the fifth aspect of the present invention, the direction of the magnetic field provided by the first feed loop (38) to the second feed loop (43) becomes opposite starting from the first twisting point (39) counted from the first high-frequency power source (37). Also, the direction of the magnetic field provided by the second feed loop (43) to the first feed loop (38) becomes opposite starting from the first twisting point (45) counted from the second high-frequency power source (42).

Then, the direction of the magnetic field provided by the first feed loop (38) to the second feed loop (43) becomes opposite starting from the next twisting point (40) of the first feed loop (38), while the direction of the magnetic field provided by the second feed loop (43) to the first feed loop (38) becomes opposite staring from the next twisting point (46) of the second feed loop (43). Thereafter, the same operation is repeated through to respective longitudinal ends of the first feed loop (38) and the second feed loop (43).

Accordingly, the induced voltages induced in the second feed loop cancel each other by a predetermined amount starting from each position corresponding to each of the twisting points of the first feed loop, while the induced voltages induced in the first feed loop cancel each other by a predetermined amount starting from each position corresponding to each of the twisting points of the second feed loop. Therefore, a value of aforementioned mutual inductance M can be reduced, and thus a shift amount of resonance frequency can be reduced.

According to a sixth aspect of the present invention, it is preferable that distances between the each two adjacent twisting points of the first feed loop are equal, and each of the twisting points of the second feed loop is arranged so as to correspond to a midpoint between the each two adjacent twisting points of the first feed loop.

With such configuration, the predetermined amount to be cancelled each other is equal to the induced voltage induced in the second feed loop starting from each of the twisting points of the first feed loop, and also equal to the induced voltage induced in the first feed loop starting from each of the twisting points of the second feed loop. Therefore, a resulting state is the same as a state where the aforementioned mutual inductance M is

Since a phase of a first current and a phase of a second current are 0 degree in a section A2 from the high-frequency power source to the first twisting point, a resultant current amplitude of the currents is doubled, and it is possible to collect current in the section A2. In a section B2 from the first twisting point of the first feed loop to the first twisting point of the second feed loop, the phase of the first current is 180 degrees and the phase of the second current is 0 degree. Therefore, current amplitudes of the first and second currents cancel each other, and it is impossible to collect current in the section B2. In subsequent sections, it is alternately possible or impossible to collect current.

According to a seventh aspect of the present invention, the double loop structure may further include a current phase controller that controls a phase difference between the first current flowing in the first feed loop and the second current flowing in the second feed loop to be 90 degrees, so that stable power supply may be achieved.

In the section A2 (excluding the twisting point (39)) from the high-frequency power source (37) to the first twisting point (39) of the first feed loop (38), a difference between the phase of the first current and the phase of the second current is constantly 90 degrees since the phase difference between the first current and the second current is controlled to be constantly 90 degrees by a current phase controller (50). Therefore, it is possible in the section A2 to collect current in the first feed loop and the second feed loop.

In the section B2 (excluding the twisting point (45)) from the twisting point (39) of the first feed loop to the first twisting point (45) of the second feed loop, the phase of the first current is shifted by 180 degrees starting from the twisting point (39) of the first feed loop, but the difference between the phase of the first current and the phase of the second current remains 90 degrees. Therefore, it is possible in the section B2, as in the section A2, to collect current in the first feed loop and the second feed loop.

In a section C2 (excluding the twisting point (40)) from the twisting point (45) of the second feed loop to the next twisting point (40) of the first feed loop, the phase of the second current is shifted by 180 degrees starting from the twisting point (45) of the second feed loop, the difference between the phase of the first current and the phase of the second current remains 90 degrees.

As described above, the phase difference between the first current and the second current may be constantly kept at 90 degrees and it is possible to collect current in any section of the first feed loop and the second feed loop. Thus, it is possible to eliminate any section, in which collection of current is impossible, in the first feed loop and the second feed loop, to thereby achieve more stable power supply.

### BRIEF DESCRIPTION OF THE DRAWINGS

The present invention will now be described by way of example with reference to the accompanying drawings, in which:

FIG. 1A is a view showing a double loop structure in a first embodiment of the present invention;

FIG. 1B is a graph showing a relationship between an induced voltage induced in a waiting feed loop and a distance from a high-frequency power source;

FIG. 1C is a view showing Modified Example 1 of the first embodiment;

FIG. 1D is a view showing Modified Example 2 of the first embodiment;

FIGS. 2A-2C are views showing examples of arrangement of the double loop structure;

FIG. 3 is a view showing an example of the double loop structure in a case where there is a shift in resonance frequency;

FIG. 4A is a view showing a double loop structure in a second embodiment of the present invention;

FIG. 4B is a view for illustrating a principle that a value of mutual inductance M is made zero;

FIG. 5 is a view showing an example of arrangement of the double loop structure in FIG. 4A;

FIG. 6A is a graph showing resonance frequency characteristics in a regular feed loop in the first embodiment;

FIG. 6B is a graph showing resonance frequency characteristics in a regular feed loop in FIGS. 2A-2C;

FIG. 6C is a graph showing resonance frequency characteristics in a regular feed loop in the second embodiment;

FIGS. 7A-7B are views showing a double loop structure in a third embodiment of the present invention; and

FIG. 8 is a graph showing a relationship between an induced voltage induced in a waiting feed loop and a distance from a high-frequency power source in a conventional example.

### DETAILED DESCRIPTION OF THE PREFERRED EMBODIMENTS

### First Embodiment

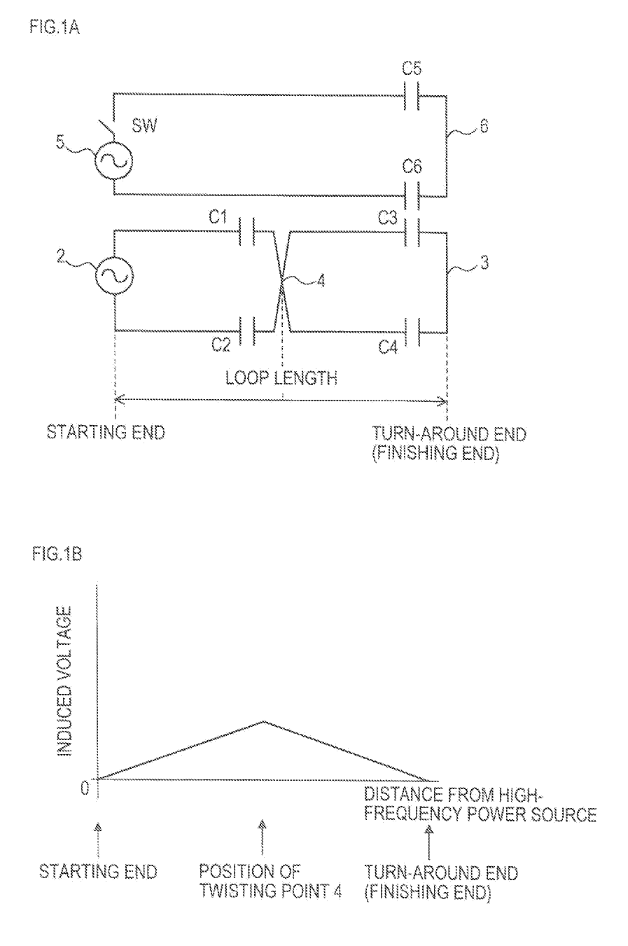

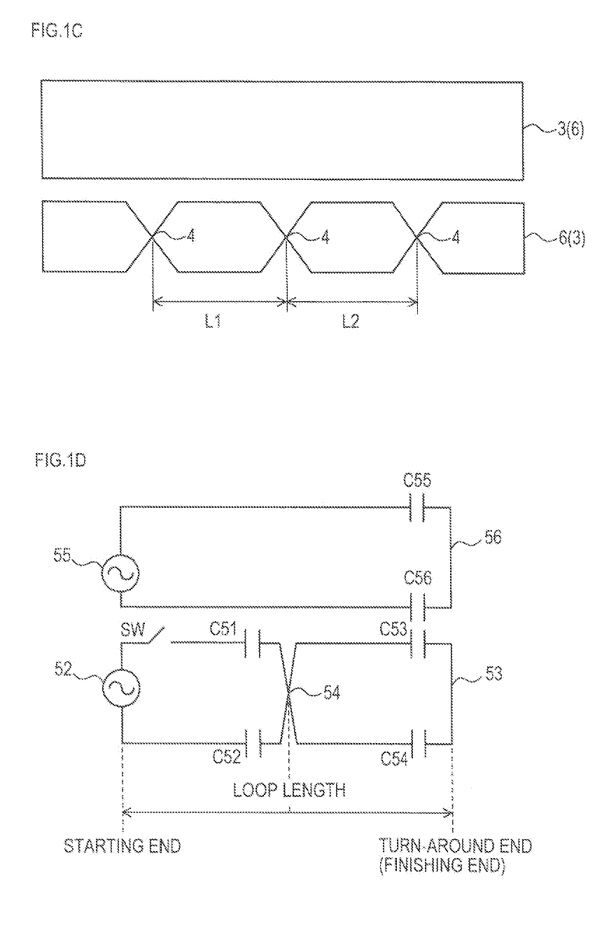

A first embodiment of the present invention will be described below with reference to FIGS. 1A-1B.

A double loop structure in the first embodiment includes a regular feed loop 3 as a first feed loop which is constantly energized and a waiting feed loop 6 as a second feed loop that serves as a backup feed loop which is not energized in a normal situation. Hereinafter, a position of a high-frequency power source is regarded as a starting end, a longitudinal end of the waiting loop (a turn-around end of the loop) is regarded as a finishing end, and a distance from the position of the high-frequency power source to the turn-around end of the loop is referred to as a loop length. (see FIG. 1A).

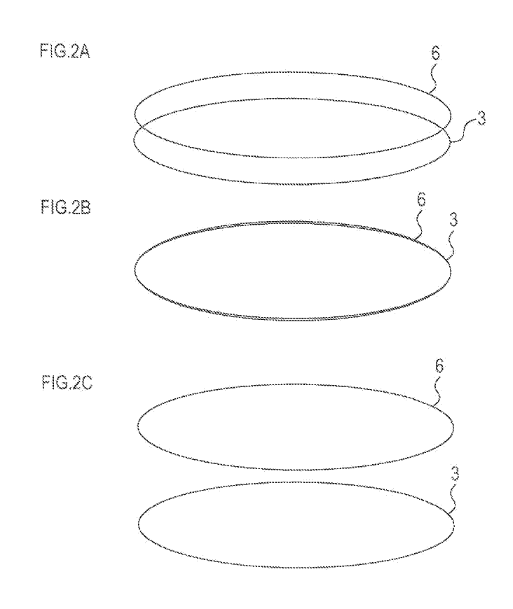

Examples of arrangement of the regular feed loop 3 and the waiting feed loop 6 constituting the double loop structure will be described with reference to FIGS. 2A-2C, each of which is a view seen from directly above the double loop structure. Twisting points provided in the regular feed loop 3 are omitted in FIGS. 2A-2C for convenience sake since these figures are views for showing the examples of arrangement of the double loop structure.

In a first example, as shown in FIG. 2A, the regular feed loop 3 and the waiting feed loop 6 are arranged to be mutually shifted by a predetermined distance in a horizontal direction, and the waiting feed loop 6 partially overlaps the regular feed loop 3 at a predetermined space apart above the regular feed loop 3 (hereinafter referred to as a “partially overlapping arrangement”).

In a second example, as shown in FIG. 2B, the regular feed loop 3 and the waiting feed loop 6 are arranged without mutual shift in a horizontal direction, and the waiting feed loop 6 completely overlaps the regular feed loop 3 at a predetermined space apart above the regular feed loop 3 (hereinafter referred to as a “completely overlapping arrangement”).

Other than the above examples of arrangement in which the loops overlap each other, there may be another example, as shown in FIG. 2C, in which the regular feed loop 3 and the waiting feed loop 6 are arranged side by side without overlapping each other and at a predetermined space apart horizontally (hereinafter referred to as a “side-by-side arrangement”).

An explanation hereinafter is given regarding a case where the regular feed loop 3 and the waiting feed loop 6 are in the partially overlapping arrangement. Also, a double loop structure in each of later-described second and third embodiments will be explained regarding a case where double loops are in the partially overlapping arrangement.

Each of the regular feed loop 3 and the waiting feed loop 6 has a closed-loop structure connected to a high-frequency power source, and may be, for example, an elliptical loop or a substantially rectangular loop. The regular feed loop 3 and the waiting feed loop 6 have a same loop length.

The regular feed loop 3 is connected to a high-frequency power source 2, and is provided with condensers C1 and C2, a condenser C4 which is connected to the condenser C1 through a twisting point 4, and a condenser C3 which is connected to the condenser C2 through a twisting point 4.

The waiting feed loop 6 is connected to a high-frequency power source 5 having a same frequency as the high-frequency power source 2, and is provided with condensers C5 and C6. A switch SW is provided between the high-frequency power source 5 and the condenser C5. During a normal time, the switch SW is off and the waiting feed loop 6 is not energized.

In an example shown in FIG. 1A, the twisting point 4 in the regular feed loop 3 has a 180-degree twist (one twist). The reason for employing the 180-degree twist is that a direction of a magnetic field provided to the waiting feed loop 6 (a direction of an induced voltage induced in the waiting feed loop 6) on a side of the high-frequency power source 2 (a front side) seen from the twisting point 4, and a direction of a magnetic field provided to the waiting feed loop 6 (a direction of an induced voltage induced in the waiting feed loop 6) on a side of the turn-around end (a rear side) can be mutually opposite, as described later.

Other than the aforementioned one twist, an odd number of twists, such as three twists, five twists, or the like, may be employed. This is because the direction of the magnetic field provided to the waiting feed loop 6 can be made opposite starting from the twisting point 4 in a same manner as in a case of one twist when an odd number of twists are given.

In the example shown in FIG. 1A, the twisting point 4 is positioned at a midpoint of the loop length of the regular feed loop 3. The regular feed loop 3 may be regarded as a coil having a predetermined inductance L, and an induced voltage is induced in the waiting feed loop 6 by the regular feed loop 3 when an alternating current from the high-frequency power source 2 flows through the regular feed loop 3.

As shown in FIG. 1B, the induced voltage induced in the waiting feed loop 6 increases as a distance from the high-frequency power source 2 (the starting end) connected to the regular feed loop 3 increases in a section from the high-frequency power source 2 to the twisting point 4, and decreases as the distance from the high-frequency power source 2 increases in a section from the twisting point 4 to the turn-around end (the finishing end).

The reason for the decrease of the induced voltage induced in the waiting feed loop 6 in the section from the twisting point 4 to the turn-around end is that the direction of the magnetic field provided to the waiting feed loop 6 (the direction of the induced voltage induced in the waiting feed loop 6) on the side of the high-frequency power source 2 (the front side) seen from the twisting point 4, and the direction of the magnetic field provided to the waiting feed loop 6 on the side of the turn-around end (the rear side) are mutually opposite.

In the example shown in FIG. 1A, since the twisting point 4 is positioned at the midpoint of the loop length of the regular feed loop 3, an increase in the induced voltage induced in the waiting feed loop 6 in the section from the starting end to the twisting point 4 is equal to a decrease in the induced voltage in the section from the twisting point 4 to the finishing end. As a result, the induced voltage induced in the waiting feed loop 6 at the finishing end of the waiting feed loop 6 is made zero.

If the regular feed loop 3 is not twisted, the induced voltage induced in the waiting feed loop 6 continues to increase in an entire section from the starting end to the finishing end of the waiting feed loop 6. Accordingly, increase in induced voltage can be suppressed when the regular feed loop 3 is twisted, as compared with the case where the regular feed loop 3 is not twisted.

When the twisting point 4 is not positioned at the midpoint of the loop length of the regular feed loop 3, unlike the example shown in FIG. 1A, such as a case where a distance from the starting end to the twisting point 4 is longer than a distance from the twisting point 4 to the finishing end, the induced voltage induced in the waiting feed loop 6 at the finishing end is not made zero. In this case, although the increase and the decrease in the induced voltage do not completely cancel each other as in the example shown in FIG. 1B, increase in induced voltage induced in the waiting feed loop 6 can be suppressed, as compared with the case where the regular feed loop 3 is not twisted.

### MODIFIED EXAMPLE 1

While the twisting point 4 is positioned at the midpoint of the loop length of the regular feed loop 3, in the example shown in FIG. 1A, a plurality of twisting points 4 may be provided in the regular feed loop 3 (see FIG. 1C).

Specifically, the plurality of twisting points are provided at a plurality of positions of the regular feed loop 3 such that a distance from the high-frequency power source 2 to a first twisting point and a distance between each adjacent two twisting points are all equal. More specifically, the plurality of twisting points are provided such that a distance L1 and a distance L2 are equal (see FIG. 1C). The twisting points are provided by: 1) providing the first twisting point at a position a predetermined distance apart from the high-frequency power source 2; and 2) providing the next and subsequent twisting points such that the predetermined distance between the first twisting point and the next twisting point and a distance between each two adjacent twisting points are all equal through to the finishing end of the regular feed loop 3.

According to the configuration described above, since the direction of the magnetic field provided to the waiting feed loop 6 (the direction of the induced voltage) on the side of the high-frequency power source 2 (the front side) seen from the each twisting point, and the direction of the magnetic field (the direction of the induced voltage) on the side of the turn-around end (the rear side) are mutually opposite, the induced voltage on the front-side and the induced voltage on the rear-side with respect to each twisting point cancel each other starting from the each twisting point. Accordingly, the induced voltage induced in the waiting feed loop 6 will not continue to increase. Thus, increase in induced voltage can be suppressed.

There may be another modified example in which the waiting feed loop 6 is provided with a plurality of twisting points 4 (see FIG. 1C).

### MODIFIED EXAMPLE 2

The double loop structure in the first embodiment includes the regular feed loop 3 and the waiting feed loop 6, in which an induced voltage is induced by the regular feed loop 3, and the regular feed loop 3 is twisted such that the direction of the magnetic field provided to the waiting feed loop 6 becomes opposite starting from the twisting point 4. However, the double loop structure may have a configuration, as shown in FIG. 1D, in which a regular feed loop and a waiting feed loop, in which an induced voltage is induced by the regular feed loop, are included, and the waiting feed loop is twisted such that the direction of the magnetic field provided by the regular feed loop to the waiting feed loop becomes opposite starting from a twisting point.

The double loop structure shown in FIG. 1D includes a waiting feed loop 53 and regular feed loop 56. The waiting feed loop 53 is connected to a high-frequency power source 52, and is provided with condensers C51 and C52, a condenser C54 which is connected to the condenser C51 through a twisting point 54, and a condenser C53 which is connected to the condenser C52 through the twisting point 54. A switch SW is provided between the high-frequency power source 52 and the condenser C51. During a normal time, the switch SW is off and the waiting feed loop 53 is not energized. The waiting feed loop 56 is connected to a high-frequency power source 55 having a same frequency as the high-frequency power source 52, and is provided with condensers C55 and C56.

Also according to such configuration, the induced voltage induced in the waiting feed loop 53 continues to increase as a distance from the high-frequency power source 52 connected to the waiting feed loop 53 increases, while the induced voltage in the waiting feed loop 53 decreases starting from the twisting point 54 as the distance from the high-frequency power source 52 increases since the direction of the induced voltage becomes opposite starting from the twisting point 54. Thus, increase in induced voltage can be suppressed.

### Second Embodiment

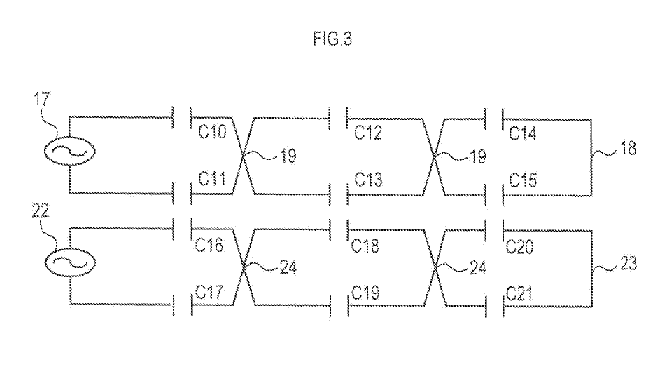

A second embodiment of the present invention will be described below with reference to FIGS. 3-6C.

A double loop structure in the second embodiment includes two regular feed loops 18, 23 which are constantly energized.

It is required in a loop structure having a high-frequency power source and a condenser to allow electric current to flow as efficiently as possible by using resonance. Specifically, in a case where a loop itself is regarded as a coil and an inductive reactance (DL) and a capacitive reactance (1/ωC) are equal, i.e., a so-called resonance condition (ωL=1/ωC) is satisfied, an impedance in the loop can be made zero. A frequency satisfying the resonance condition is referred to as a resonance frequency. The resonance frequency is obtained unambiguously so as to satisfy the resonance condition depending on an inductance L of the coil and a capacity C of the condenser.

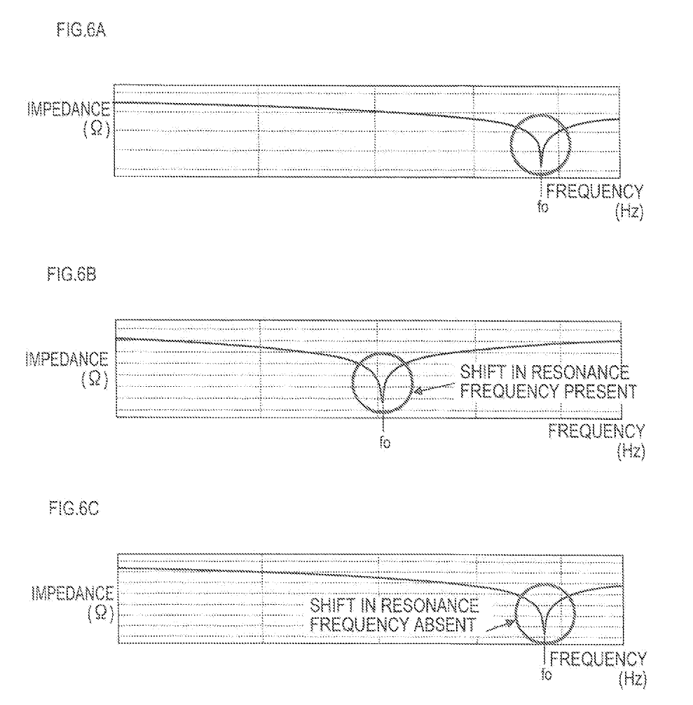

FIG. 6A shows resonance frequency characteristics in the regular feed loop in the first embodiment. A frequency f₀ having a lowest impedance (in a vertical axis), i.e., a convex portion in a circled area, is the resonance frequency.

Now, a consideration will be given to a double loop structure including two regular feed loops 18, 23 as shown in FIG. 3. In the double loop, twisting points 19, 24 are provided in the regular feed loops 18, 23, respectively, at positions a same distance apart from high-frequency power sources 17, 22, respectively. A resonance frequency f₀ in the double loop structure, which is shown in FIG. 6B, is shifted as compared with the resonance frequency f₀ in a so-called single loop structure shown in FIG. 6A. As a result, it is impossible to allow current to flow efficiently and thus is impossible to collect current.

The reason for such shift of the resonance frequency is that a factor of mutual inductance M is added in the double loop structure including two regular feed loops. Hereinafter, an explanation will be provided on a relationship between the mutual inductance M and the resonance frequency.

When an alternating current flows from an alternating current power source into each feed loop of a double loop structure, an induced voltage is induced in the each feed loop. A resonance condition of the regular feed loops 18, 23 in the double loop structure is:

ω(L+M)=1/ωC,

wherein ωL is an inductive reactance, M is a mutual inductance, and 1/ωC is a capacitive reactance.

Since the resonance frequency f₀ is determined based on the inductive reactance ωL, the capacitive reactance 1/ωC, and the mutual inductance M, the resonance frequency in the double loop structure is shifted (see FIG. 6B) due to an influence by the mutual inductance M as compared with the resonance frequency (see FIG. 6A) in the single loop structure including only one regular feed loop.

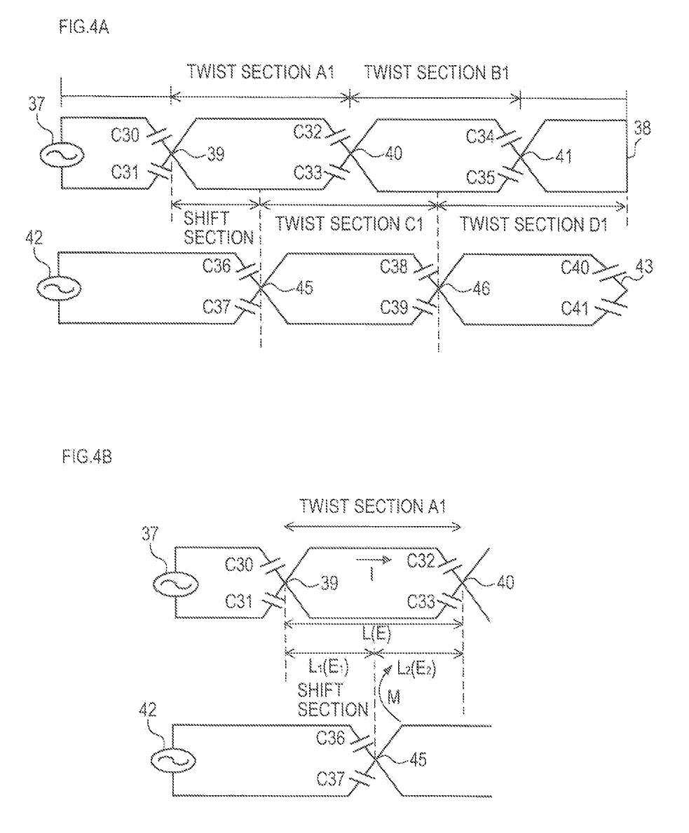

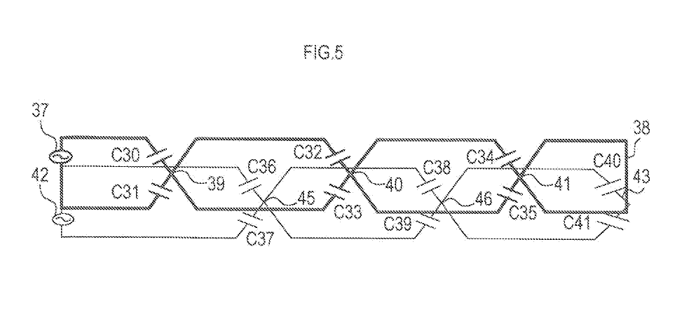

In view of this, in the second embodiment, the twisting points in the two regular feed loops 38, 43 are mutually shifted as shown in FIG. 4A, to thereby eliminate a shift in resonance frequency mentioned above. A detailed explanation on a principle of the operation will be provided below with reference to FIGS. 4A and 4B.

As shown in FIG. 4A, the double loop structure of the second embodiment is constituted by a regular feed loop 38 (a first energized loop), which is connected to a high-frequency power source 37 and energized, and a regular feed loop 43 (a second energized loop), which is connected to a high-frequency power source 42 and energized.

Although the regular feed loops 38, 43 may be arranged in the partially overlapping arrangement, the completely overlapping arrangement, or the side-by-side arrangement in a same manner as in the above-described first embodiment, the following explanation will be provided regarding a case where the regular feed loops 38, 43 are in the partially overlapping arrangement (see FIG. 5).

The regular feed loop 38 has a plurality of twisting points 39, 40, 41, which are arranged such that a distance of a first twist section A1 between the twisting point 39 and the twisting point 40 adjacent to the twisting point 39, and a distance of a second twist section B1 between the twisting point 40 and the twisting point 41 adjacent to the twisting point 40 are equal.

The regular feed loop 43 has twisting points 45, 46, which are arranged such that a distance of a first twist section C1 between the twisting point 45 and the twisting point 46 adjacent to the twisting point 45, and a distance of a second twist section D1 between the twisting point 46 and a turn-around end of the regular feed loop 43 are equal. Also, the twist sections A1, B1, C1, and D1 have a same section length.

The twisting point 45 of the regular feed loop 43 is arranged such that the twist section C1 of the regular feed loop 43 as the second energized loop is shifted by half a distance (a shift section length) of the twist section A1 of the regular feed loop 38 with respect to the twist section A1 of the regular feed loop 38. The twisting point 46 of the regular feed loop 43 is arranged such that the twist section D1 of the regular feed loop 43 is shifted by half a distance (a shift section length) of the twist section B1 of the regular feed loop 38 with respect to the twist section B1 of the regular feed loop 38.

Condensers C30, C31 are provided between the high-frequency power source 37 and the twisting point 39, condensers C32, C33 are provided between the twisting

Condensers C36, C37 are provided between the high-frequency power source 42 and the twisting point 45, condensers C38, C39 are provided between the twisting point 45 and the twisting point 46, and condensers C40, C41 are provided between the twisting point 46 and the turn-around end of the regular feed loop 43. The condensers C40, C41 have a capacitive reactance which cancels the inductive reactance of the regular feed loop 43 to thereby make zero the impedance in the regular feed loop 43.

As a result of an arrangement of the twisting points as described above, the direction of the magnetic field provided by the regular feed loop 38 to the regular feed loop 43 becomes opposite starting from the first twisting point 39 of the regular feed loop 38, while the direction of the magnetic field provided by the regular feed loop 43 to the regular feed loop 38 becomes opposite starting from the first twisting point 45 of the regular feed loop 43.

Then, the direction of the magnetic field provided by the regular feed loop 38 to the regular feed loop 43 becomes opposite starting from the next twisting point 40 of the regular feed loop 38, while the direction of the magnetic field provided by the regular feed loop 43 to the regular feed loop 38 becomes opposite starting from the next twisting point 46 of the regular feed loop 43. Thereafter, the same operation is repeated through to respective longitudinal ends of the regular feed loop 38 and the regular feed loop 43.

Accordingly, the induced voltages induced in the regular feed loop 43 completely cancel each other starting from each of the twisting points 39, 40, 41 of the regular feed loop 38, while the induced voltages induced in the regular feed loop 38 completely cancel each other starting from each of the twisting points 45, 46 of the regular feed loop 43. A resulting state is the same as a state where the mutual inductance M is zero.

An explanation will be provided below on a principle that a value of the mutual inductance M is made zero with reference to FIG. 4B.

Take a case, as an example, where a current flowing in the regular feed loop 43 is I, a mutual inductance between the regular feed loop 38 and the regular feed loop 43 is M, an angle frequency is 2πf(ω), a distance from the twisting point 39 to a position corresponding to the twisting point 45 of the regular feed loop 38 is L₁, a distance from the corresponding position to the twisting point 40 is L₂. In this case, an induced voltage E₁ induced in the regular feed loop 38 by the regular feed loop 43 at the distance L₁ is 2πfMIL₁, and an induced voltage E₂ induced in the regular feed loop 38 by the regular feed loop 43 at the distance L₂ is 2πfMIL₂.

Since directions of the induced voltage E₁ and the induced voltage E₂ induced in the regular feed loop 38 become mutually opposite starting from the twisting point 45, an induced voltage E (E₁+E₂), which is induced in the regular feed loop 38 by the regular feed loop 43 at a distance L(=L₁+L₂), is 2πfMI(L₁−L₂).

Accordingly, when the distance L₁ is equal to the distance L₂, a resulting state is the same as a state where the mutual inductance M is zero, and the resonance condition is ωL=1/ωC instead of ω(L+M)=1/ωC. Thus, it is possible to completely eliminate a shift in resonance frequency as shown in FIG. 6C according to the second embodiment.

### MODIFIED EXAMPLE 1

Although the twisting point 45 is arranged such that the twist section C1 is shifted by half the distance of the twist section A1 with respect to the twist section A1 in the example shown in FIGS. 4A-4B, a shift distance may be other than half the distance of the twist section A1.

In this case, the induced voltages induced in the regular feed loop 43 cancel each other by predetermined amounts starting from each of the twisting points 39, 40, 41 of the regular feed loop 38, while the induced voltages induced in the regular feed loop 38 cancel each other by predetermined amounts starting from each of the twisting points 45, 46 of the regular feed loop 43.

In this modified example, (L₁−L₂) in the above mentioned formula E=2πfMI(L₁−L₂) is not completely made zero, and therefore the value of the mutual inductance M cannot be made zero. However, when a shift distance is set such that (L₁−L₂) is a value less than “1”, the value of the mutual inductance M may be reduced as compared with a case of no shift. Thus, an amount of shift in resonance frequency may be reduced.

### Third Embodiment

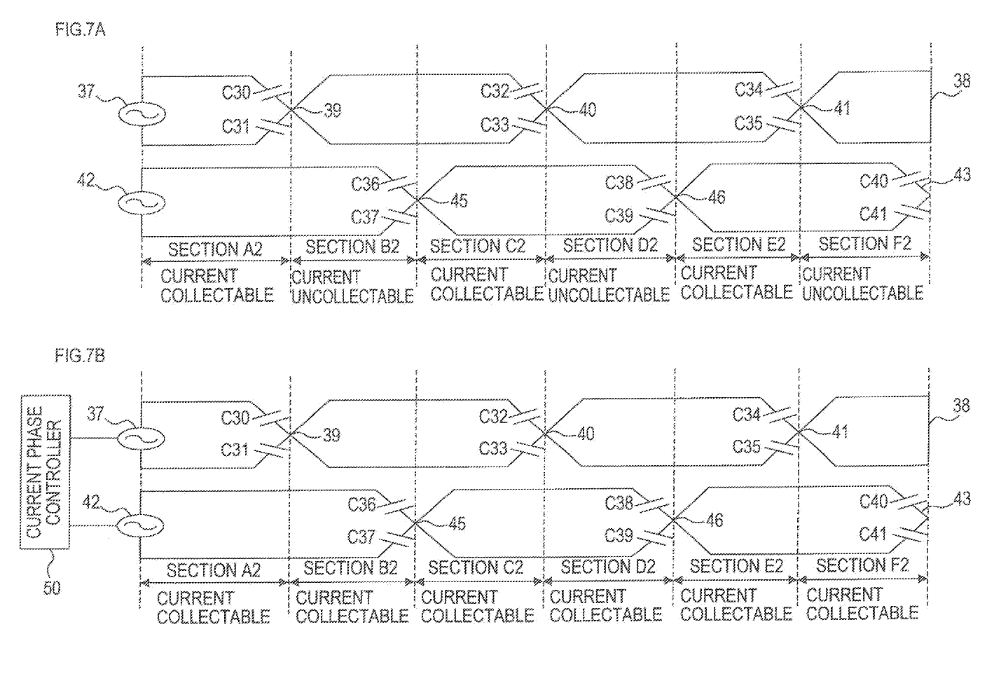

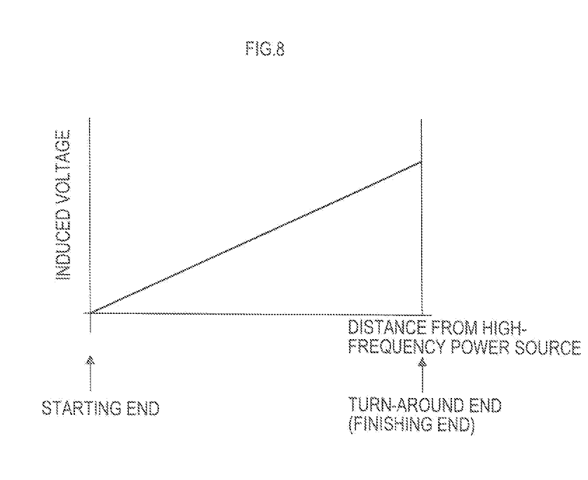

A third embodiment of the present invention will be described below with reference to FIGS. 7A-7B. Since the double loop structure in the third embodiment is the same as in the above-described one shown in FIG. 4A, no further explanation will be provided here.

In the above-described second embodiment, a phase of a first current flowing in the regular feed loop 38 in a section A2 (excluding the twisting point 39) from the high-frequency power source 37 to the first twisting point 39 is set as “0” degree, and a phase of a second current flowing in the regular feed loop 43 is set as “0” degree. Since the phase of the first current and the phase of the second current are the same (“0” degree), a resultant amplitude of the first current and the second current is double an amplitude of each of the first current and the second current, and it is possible to collect current in the section A2 (see FIG. 7A).

However, in a section B2 (excluding the twisting point 45) from the first twisting point 39 to the first twisting point 45 of the regular feed loop 43, the phase of the first current is 180 degrees, and a difference between the phase of the first current and the phase of the second current is 180 degrees. As a result, a resultant amplitude of the first current and the second current is zero, and it is impossible to collect current in the section B2 (see FIG. 7A).

In a section C2 (excluding the twisting point 40) from the first twisting point 45 of the regular feed loop 43 to the next twisting point 40 of the regular feed loop 38, the phase of the first current remains 180 degrees and the phase of the second current 2 is 180 degrees. Since the phase of the current in the regular feed loop 38 and the phase of the current in the regular feed loop 43 are the same, a resultant amplitude of the first current and the second current is double the amplitude of each of the first current and the second current, and it is possible to collect current in the section C2. Collection of current is: impossible in a section (a section D2) from the twisting point 40 of the regular feed loop 38 to the next twisting point 46 of the regular feed loop 43; possible in a section (a section E2) from the twisting point 46 of the regular feed loop 43 to the twisting point 41 of the regular feed loop 38; and impossible in a section (a section F2) from the twisting point 41 of the regular feed loop 38 to the longitudinal end.

According to the double loop structure in the third embodiment, the aforementioned section, in which collection of current is impossible, is eliminated by means of a later-described method, so that more stable collection of current (power supply) can be performed. A detailed explanation will be provided below on a principle to eliminate the section, in which collection of current is impossible, with reference to FIG. 7A-7B.

In the third embodiment, as shown in FIG. 7B, a current phase controller 50 is connected to the high-frequency power sources 37, 42. The current phase controller 50 controls the high-frequency power sources 37, 42 such that a phase difference between the current flowing in the regular feed loop 38 (the first current) and the current flowing in the regular feed loop 43 (the second current) is constantly kept at 90 degrees.

### Collection of Current in Section A2

In the section A2 (excluding the twisting point 39) from the high-frequency power source 37 to the first twisting point 39, a difference (β−α) between the phase (α degrees) of the first current flowing in the regular feed loop 38 and the phase (β degrees) of the second current flowing in the regular feed loop 43 is 90 degrees. Therefore, the resultant amplitude of the currents is doubled, and it is possible to collect current in the section A2 (see FIG. 7A).

Accordingly, a calculated amount of the collected current (i.e., the resultant amplitude of the first current and the second current) in the section A2 is approximately 1.4 (√2) times an amount of current (a reference amount of collected current) collectable by the regular feed loop 38 only or the regular feed loop 43 only.

### Collection of Current in Section B2

In the section B2 (excluding the twisting point 45) from the first twisting point 39 to the first twisting point 45 of the regular feed loop 43, the phase of the first current is (α+180) degrees, and the phase of the second current remains β degrees. Therefore, a difference between the phase of the first current (α+180) degrees and the phase of the second current β degrees remains 90 degrees.

Accordingly, a calculated amount of the collected current (i.e., the resultant amplitude of the first current and the second current) in the section B2 is approximately 1.4 (√2) times an amount of current (the reference amount of collected current) collectable by the regular feed loop 38 only or the regular feed loop 43 only.

### Collection of Current in Section C2

In the section C2 (excluding the twisting point 40) from the twisting point 45 of the regular feed loop 43 to the twisting point 40 of the regular feed loop 38, the phase of the first current remains (α+180) degrees, and the phase of the second current is (β+180) degrees. Therefore, a difference between the phase of the first current (α+180) degrees and the phase of the second current (β+180) degrees remains 90 degrees.

Accordingly, a calculated amount of the collected current (i.e., the resultant amplitude of the first current and the second current) in the section C2 is approximately 1.4 (√/2) times an amount of current (the reference amount of collected current) collectable by the regular feed loop 38 only or the regular feed loop 43 only. In the subsequent sections D2-F2, the same operation is repeated and approximately 1.4 (√/2) times the reference amount of collected current can be constantly obtained. Since the same operation as in the aforementioned sections B2 and C2 is performed in the sections D2-F2, no further detailed explanation regarding the section D2-F2 will be provided here.

Accordingly, the phase difference between the first current and the second current can constantly remain 90 degrees in any section of the regular feed loop 38 and the regular feed loop 43. Thus, it is possible to eliminate any section, in which collection of current is impossible, and the operation to collect approximately 1.4 times the amount of current is constantly repeated, to thereby achieve more stable power supply.

### MODIFIED EXAMPLE 1

In the above-described third embodiment, the current phase controller 50 controls the high-frequency power source 37 of the regular feed loop 38 and the high-frequency power source 42 of the regular feed loop 43 such that the phase difference between the first current and the second current is constantly kept at 90 degrees. However, it may be configured to control only the high-frequency power source 37 such that only the phase of the first current flowing in the regular feed loop 38 is shifted by 90 degrees with respect to the phase of the second current flowing in the regular feed loop 43. In this case, the current phase controller 50 is connected only to the high-frequency power source 37.

Alternatively, it may be configured to control only the high-frequency power source 42 such that only the phase of the second current flowing in the regular feed loop 43 is shifted by 90 degrees with respect to the phase of the first current flowing in the regular feed loop 38. In this case, the current phase controller 50 is connected only to the high-frequency power source 42.

### MODIFIED EXAMPLE 2

In the above-described third embodiment, control is performed such that the current phases are mutually shifted by 90 degrees, to thereby allow constant collection of current of approximately 1.4 times the reference amount of collected current. However, even when the current phases are mutually shifted by a degree other than 90 degrees, an effect of eliminating any section, in which collection of current is impossible, can be achieved although each section may have a different collectable current amount.

Although the embodiments of the present invention have been described above, the present invention should not be limited to the above-described embodiments, but may be practiced in various forms without departing from the gist of the present invention.

What is claimed is:

1. A double loop structure comprising:
a first feed loop that is connected to a first high-frequency power source and energized; and
a second feed loop which is connected to a second high-frequency power source, and in which an induced voltage is induced by the first feed loop,
wherein the first feed loop is provided with at least one twisting point a predetermined distance apart from the first high-frequency power source.

2. A double loop structure comprising:
a first feed loop that is connected to a first high-frequency power source and energized; and
a second feed loop which is connected to a second high-frequency power source, and in which an induced voltage is induced by the first feed loop,
wherein the second feed loop is provided with at least one twisting point a predetermined distance apart from the second high-frequency power source.

3. The double loop structure according to claim 1, wherein the first feed loop is provide with a plurality of twisting points such that distances between each two adjacent twisting points are equal.

4. The double loop structure according to claim 2, wherein the second feed loop is provided with a plurality of twisting points such that distances between each two adjacent twisting points are equal.

5. A double loop structure comprising:
a first feed loop that is connected to a first high-frequency power source and energized; and
a second feed loop that is connected to a second high-frequency power source and energized,
wherein the first feed loop is provided with a plurality of twisting points, and
wherein the second feed loop is provided with a plurality of twisting points, each being arranged so as to correspond to a section between each two adjacent twisting points of the first feed loop.

6. The double loop structure according to claim 5,
wherein distances between the each two adjacent twisting points of the first feed loop are equal, and
wherein each of the twisting points of the second feed loop is arranged so as to correspond to a midpoint between the each two adjacent twisting points of the first feed loop.

7. The double loop structure according to claim 5, further comprising a current phase controller that controls a phase difference between the first current flowing in the first feed loop and the second current flowing in the second feed loop to be 90 degrees.
